(19) United States
(12) Patent Application Publication
(10) Pub. No.: US 2004/0168180 A1
(43) Pub. Date: Aug. 26, 2004

(54) Optical disc drive

(76) Inventor: Chih-Sheng Wei, Taoyuan (TW)

Correspondence Address: QUINTERO LAW OFFICE, 1617 BROADWAY, 3RD FLOOR, SANTA MONICA, CA, 90404, US

(21) Appl. No.: 10/780,053

(22) Filed: Feb. 17, 2004

(30) Foreign Application Priority Data
Feb. 25, 2003 (TW) 92202922

(51) Int. Cl. G11B 17/00; G11B 21/16

(52) U.S. Cl. 720/692; 720/694

(57) ABSTRACT

An optical disc drive. The optical disc drive includes a main body, a motor, a vibration absorber, and a balance plate. The motor and the vibration absorber are disposed on the main body. The balance plate is disposed on the vibration absorber such that the center of gravity of the vibration absorber and the balance plate is substantially close to the center of gravity of the main body.

### BACKGROUND OF THE INVENTION

1. Field of the Invention

The present invention relates to an optical disc drive, and in particular to use of a balance plate to enhance the function of a vibration absorber of the optical disc drive.

2. Description of the Related Art

As optical media technology has rapidly improved in recent years, various kinds of optical disc drives are involved in applications as computer peripherals. Presently, most commercially available optical disc drives are made to operate with a rotational speed of the spindle motor over 10000 rpm. However, optical discs loaded into an optical disc drive may be eccentric. When the spindle motor of the optical disc drive is operated at a relatively high rotational speed, centrifugal force due to imbalance of the eccentric disc increases and may lead to vibration or noise.

This vibration creates instability that impairs the optical pickup head of the optical disc drive, so that errors occur in data readout, and resulting noise can be annoying or even hazardous to the user. Furthermore, reading data from unstable optical discs may deteriorate performance of the optical disc drive. Accordingly, elimination of vibration and noise at high rotational speeds is a major concern for manufacturers.

Conventionally, there are three methods of reducing vibration and noise in optical disc drives due to the operation of motor at high speed.

In one conventional method, extra weight is applied to the data readout device (i.e. the “mecha”) of the optical disc drive. This method directly increases the weight of the optical disc drive and attempts to reduce vibration. Unfortunately, vibration is not significantly reduced.

Another method of reducing the vibration of the optical disc drive uses an additional auto-balancing system in the optical disc drive. In the auto-balancing system, a balancing component is applied. In practical use, however, this method is limited by manufacturing factors such as concentricity or roughness, and it is not possible to apply a single specific balancing component to deal with all various types of eccentric discs. Obviously, the many specific components required create more cost.

The third method applies a dynamic vibration absorber in accordance with vibration theory. The dynamic vibration absorber includes a resilient member or an absorber, provided either above or below the base of the optical disc drive. According to the vibration theory, when the resilient member has a natural frequency that is equal to the harmonic frequency of the base in vibration, the base has a displacement of zero. That is, the resilient member absorbs vibration from the base.

FIG. 1 shows a conventional dynamic vibration absorber commonly used in optical disc drives. In FIG. 1, a plurality of resilient dampers 12 are provided between the absorber 10 and the main body 11. A plurality of vibration isolating dampers 13 are provided between the base 11 and the base supporting device (not shown in Fig.). A plurality of screws fasten the absorber 10, the dampers 12 and the vibration isolating dampers 13 to the main body 11.

However, in the conventional dynamic vibration absorber, the shape and size of the absorber 10 are limited by the main body 11, such that it is difficult to apply extra weight in the position corresponding to the center of gravity of the main body 11. As a result, vibration cannot be significantly reduced. Consequently, there is a need to develop a dynamic vibration absorbing apparatus for the optical disc drive without the above-mentioned disadvantages. SUMMARY OF THE INVENTION

Accordingly, an object of the invention is to provide an optical disc drive, including a main body, a motor, a vibration absorber, and a balance plate. The motor and the vibration absorber are disposed on the main body. The balance plate is disposed on the vibration absorber such that the center of gravity of the vibration absorber is substantially close to the center of gravity of the main body.

According to the present invention, vibration and noise in the optical disc drive at high rotational speeds are reduced, and the optical disc drive according to the present invention can be easily manufactured and constructed. Furthermore, the balance plate not only adds extra weight to the absorber to extend the frequency of vibration absorption but also enhances the vibration absorbing ability of the vibration absorber since the special position of the balance plate brings the center of gravity of the absorber close to that of the main body and the vibration source.

The invention also provides an optical disc drive including a plurality of screws to fasten the vibration absorber to the main body and a plurality of resilient members disposed between the screws and the main body, wherein the resilient members act as dampers due to the coefficient of elasticity thereof. Since the center of gravity of the main body is near a first side of the vibration absorber, the screws are tighter when disposed close to the first side and the coefficients of elasticity of the resilient members increase when the plurality of resilient members is disposed close to the first side.

According to the present invention, the configuration described above enhances the effectiveness of the vibration absorber.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional dynamic vibration absorber commonly used in an optical disc drive;

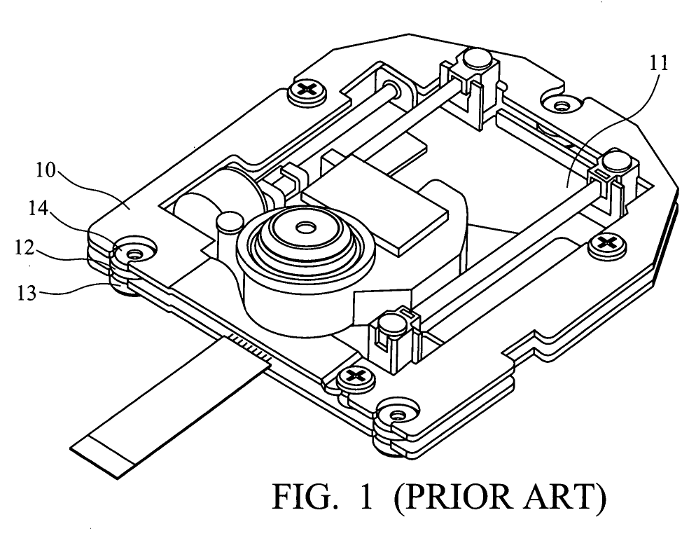

FIG. 2 is an exploded view of the vibration absorbing apparatus of the present invention;

FIG. 3 is an equivalent free body diagram of the optical disc drive of the invention;

FIG. 4 shows a simulated result of adding a balance plate to the vibration absorber.

### DETAILED DESCRIPTION OF THE INVENTION

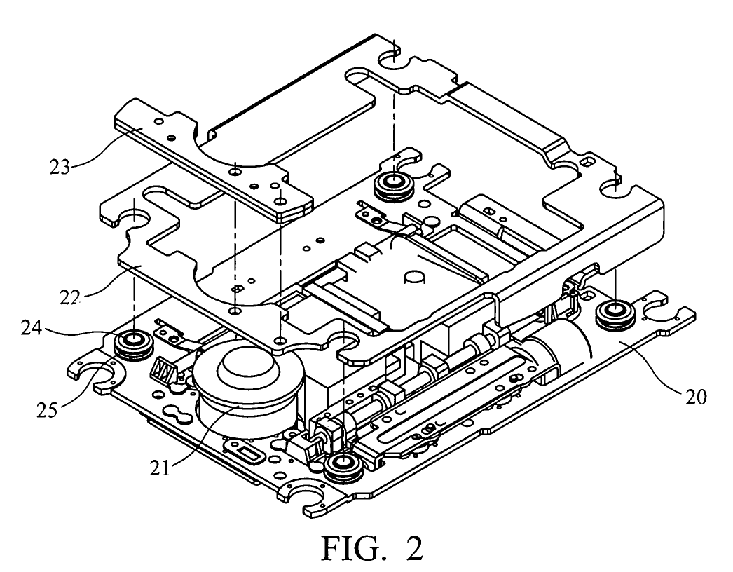

FIG. 2 is an exploded view of the vibration absorbing apparatus of the present invention. The optical disc drive includes a main body 20, a motor 21, a vibration absorber 22, and a balance plate 23. The motor 21 is a vibration source disposed on the main body 20 and brings the center of gravity of the main body 20 close to the motor 21. The vibration absorber 22 is disposed on the main body 20. The balance plate 23 is disposed in the vibration absorber 22 by screwing or adhesion such that the center of gravity of the vibration absorber 22 nears the center of gravity of the main body 20. In the present embodiment, the vibration absorber 22 is a hollow frame having a first side adjacent to the motor 21 on the main body 20 and the balance plate 23 is disposed on the first side of the vibration absorber 22.

In addition, the vibration absorber 22 of the optical disc drive further includes four screws 24 and four resilient members 25, wherein the screws fasten the vibration absorber 22 to the main body 20, the resilient members 25 are disposed between the screws 24 and the main body 20 respectively, the resilient members act as vibration absorbing or isolating dampers due to coefficients of elasticity (k) and the damping value (c) thereof. Furthermore, since the center of gravity of the main body 20 is near the first side of the vibration absorber 22, the screws 24 are tighter when disposed close to the first side and the coefficients of elasticity of the resilient members 25 increase when the resilient members are disposed close to the first side.

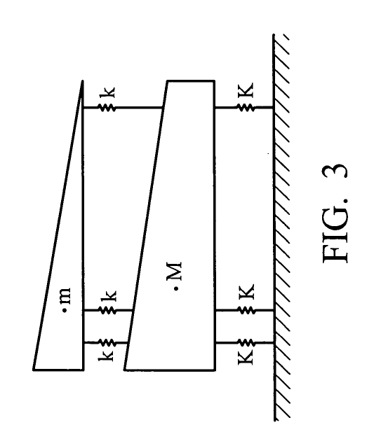

FIG. 3 is an equivalent free body diagram of the embodiment of the invention as shown in FIG. 2, wherein “M” is the center of gravity of the main body having the vibration source, e.g. the motor, “m” is the center of gravity of the vibration absorber, “K” is the coefficient of elasticity between the main body having the motor and the chassis (not shown in FIG. 2) of the optical disc drive, and “k” is the coefficient of elasticity of the resilient member disposed between the vibration absorber and the main body.

According to the present invention, the balance plate 23 is applied to increase weight on the optical disc drive and to bring the center of gravity of the vibration absorber 22 and the main body 20 nearer, wherein the extra weight due to the balance plate extends the range of the frequency of vibration absorption between 150-200 Hz, and the amplitude of vibration can be adjusted, and operation frequency of the optical disc drive can also be reduced. Meanwhile, since the centers of gravity of the main body 20 and the vibration absorber 22 are close, the main body 20 and the vibration absorber 22 are prevented from twisting during vibration and the vibration motion can limited to one dimension.

In addition, due to the displacement of the centers of gravity of the main body 20 and the vibration absorber 22, the coefficients of the resilient members 25 are different according to the distance between the resilient members 25 to the centers of gravity of the main body 20 and the vibration absorber 22 respectively. In the present embodiment, the resilient members 25 fastened by the screws 24 are used as dampers or springs and are made of rubber with various coefficients of elasticity k. As shown in FIG. 3, the coefficients of elasticity of the resilient members 25 increase when the resilient members are disposed close to the centers of gravity of the main body 20 and the vibration absorber 22. In practice, the resilient member near the center of gravity is a spring or a rubber pad with larger coefficient of elasticity. In another embodiment, the screws can be tighter to increase pre-depressed displacement of the resilient member 25 such that it duplicates the effect of using the resilient member with larger coefficient of elasticity.

Moreover, the resilient members 25 can not only be disposed between the vibration absorber 22 and the main body 20 but also between the main body 20 and the chassis (not shown in Fig.) of the optical disc drive, which can further reduce vibration. The balance plate 23 can not only be disposed on the vibration absorber 22 but also between the vibration absorber 22 and the main body 20. However, the shape of the balance plate 23 will be modified according to its position on the vibration absorber.

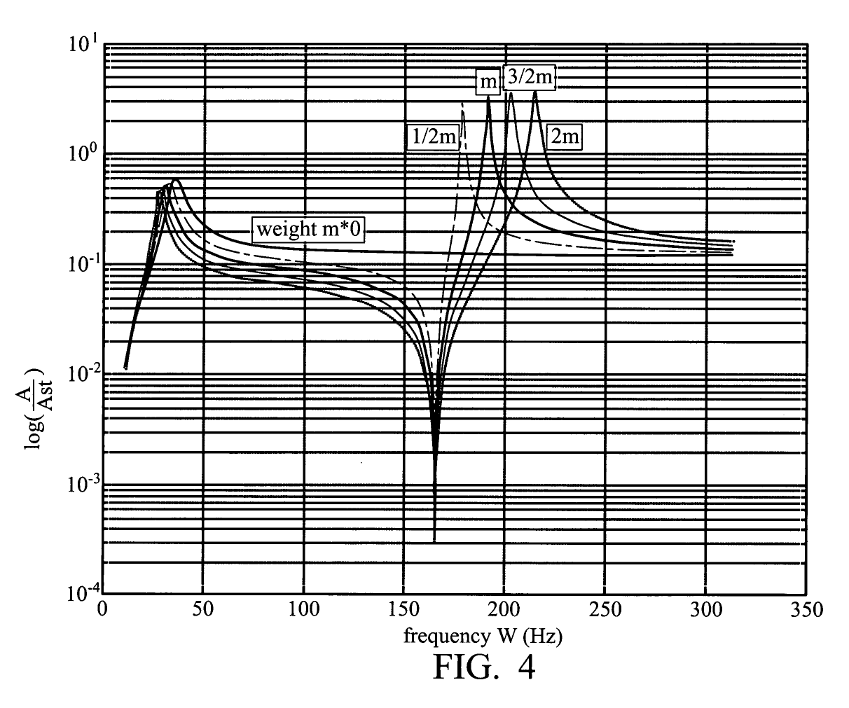

FIG. 4 shows a simulated result of adding balance plate on the vibration absorber according to the vibration theory

$$\frac{A}{{A}_{st}} = \frac{{Ω}_{n}^{2} ( {ω}_{n}^{2} - {ω}^{2} )}{( {Ω}_{n}^{2} - {ω}^{2} ) ( {ω}_{n} - {ω}^{2} ) - μ {ω}_{n}^{2} {ω}^{2}} ,$$

wherein A=amplitude of vibration, Aₛₜ=maximum amplitude of vibration,

$${ω}_{n} = \sqrt{\frac{k}{m}} = \text{natural frequency of the vibration absorber,}$$

=natural frequency of the vibration absorber, k coefficient of elasticity between the vibration absorber and the main body, m=mass of the vibration absorber,

$${Ω}_{n} = \sqrt{\frac{K}{M}} = \text{natural frequency of the main body,}$$

=natural frequency of the main body, K=coefficient of elasticity between the main body and the chassis, M=mass of the main body, ω=operation frequency, and

$$μ = \frac{m}{M} .$$

Substituting m=0.0716 Kg, M=0.2167 Kg, ωₙ=167 Hz, Ωₙ=35 Hz, ω=150˜150 Hz as simulation conditions, when no vibration absorber is disposed (m=0), amplitude ratio

$$( \frac{A}{{A}_{si}} )$$

cannot be absorbed. After the vibration absorber is disposed, vibration absorption is effected between about the operation frequency=150˜120 Hz due to the amplitude of the vibration absorber and the main body being in opposite directions. In the same operation frequency, with increased mass of the vibration absorber, the amplitude ratio

$$( \frac{A}{{A}_{si}} )$$

decreases. In FIG. 4, the V-shaped openings show vibration absorbing region, wherein the wider the opening, the broader the range of the operation frequency of vibration absorption.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical disc drive, comprising:
a main body having a first center of gravity;
a motor disposed on the main body;
a vibration absorber, disposed on the main body, having a second center of gravity; and
a balance plate disposed on the vibration absorber, whereby the second center of gravity of the vibration absorber is substantially close to the first center of gravity of the main body.

2. The optical disc drive as claimed in claim 1, wherein the vibration absorber is a frame having a first side adjacent to the motor, with the balance plate disposed on the first side.

3. The optical disc drive as claimed in claim 1, wherein the vibration absorber further comprises:
a plurality of screws for fixing the vibration absorber to the main body; and
a plurality of resilient members disposed between the plurality of screws and the main body.

4. The optical disc drive as claimed in claim 3, wherein the plurality of screws is screwed more tightly when disposed closer to the first side.

5. The optical disc drive as claimed in claim 3, wherein the coefficients of elasticity of the plurality of resilient members increase when the plurality of resilient members is disposed closer to the first side.

6. The optical disc drive as claimed in claim 3, wherein the resilient members are springs.

7. The optical disc drive as claimed in claim 3, wherein the resilient members are rubber pads.
